(19) United States
(12) Patent Application Publication
(10) Pub. No.: US 2024/0311720 A1
(43) Pub. Date: Sep. 19, 2024

(54) SYSTEM AND METHOD FOR DYNAMIC VIRTUAL GROUPING OF NODES

(71) Applicant: Target Brands, Inc., Minneapolis, MN (US)

(72) Inventors: VISAGAN VAITHYANATHAN, Minneapolis, MN (US); YOGESH HD, Bengaluru (IN); KOWSHIK TALLAM, Bengaluru (IN)

(21) Appl. No.: 18/185,864

(22) Filed: Mar. 17, 2023

(51) Int. Cl. G06Q 10/0631; G06F 16/28; G06F 16/29

(52) U.S. Cl. CPC G06Q 10/06315; G06F 16/285; G06F 16/29

(57) ABSTRACT

A system and method for dynamic virtual grouping of nodes is disclosed. A clustering service may receive node data for a plurality of nodes of a supply chain. The clustering service may group the nodes into virtual clusters based on geographical coordinates and fulfillment features. In some examples, the clustering service may first group nodes into general clusters and then group nodes into subclusters. In some examples, the clustering service may provide the clusters to a fulfillment service, which may use the clusters to perform a fulfillment task.

### BACKGROUND

A supply chain may have multiple layers, each consisting of one or more nodes. An item may move from an origin node to a destination node. In some instances, an enterprise may need to determine whether an item is available in an origin node. In some instances, an enterprise may need to determine when an item may arrive at a destination node from an origin node. Performing such tasks may be challenging.

For example, nodes in a supply chain may be heterogeneous. They may have different inventories, different locations, and other different features. As a result, it may be difficult to find an origin node that satisfies all criteria to fulfill an order. For example, a first origin node may have one item of an order but not have other items of an order: a second origin node may have all items of an order, but it may not offer a requested shipping service, or it may be located too far from the destination node to be timely and/or cost-effective. Because of node differences, an enterprise may invest significant time and computational resources in interacting with possible origin nodes to determine, for example, inventory and fulfillment data. Searching nodes may be computationally expensive, may require large amounts of data, and may lead to suboptimal node selection. Such problems may be exacerbated for an enterprise that interacts with a supply chain having many possible origin nodes and that is frequently required, for various purposes, to determine inventory levels and other supply chain data, such as estimated delivery dates and available shipping services.

### SUMMARY

Aspects of the present disclosure relate to a method and system for dynamic virtual grouping of nodes. A system may include a clustering service that receives node data for a plurality of nodes of a supply chain. The node data may include geographical coordinates and fulfillment features of the nodes. The system may, based on the geographical coordinates and the fulfillment features, group the nodes into a plurality of virtual clusters. Each virtual cluster may include nodes that are relatively near one another and that are similar to one another from a fulfillment timing perspective. Having generated the clusters, the clustering service may provide the clusters to a fulfillment service, which may use the clusters to perform a fulfillment task.

In one aspect, a method for grouping a plurality of nodes of a supply chain is disclosed. The method comprises receiving a plurality of geographical coordinates for the plurality of nodes, the plurality of geographical coordinates including, for each node of the plurality of nodes, geographical coordinates corresponding to a location of the node: receiving a plurality of fulfillment features for the plurality of nodes, the plurality of fulfillment features including fulfillment features for each node of the plurality of nodes; and grouping, based on the plurality of geographical coordinates and the plurality of fulfillment features, the plurality of nodes into a plurality of clusters, each of the plurality of clusters including one or more nodes of the plurality of nodes: wherein grouping, based on the plurality of geographical coordinates and the plurality of fulfillment features, the plurality of nodes into the plurality of clusters comprises: based on one of the plurality of geographical coordinates or the plurality of fulfillment features, grouping the plurality of nodes into a plurality of general clusters; and determining a plurality of subclusters by, for each general cluster of the plurality of general clusters, grouping, based on one of the plurality of geographical coordinates or the plurality of fulfillment features, one or more nodes of the general cluster into one or more subclusters.

In another aspect, a system for facilitating supply chain operations is disclosed. The system comprises a clustering service comprising a processor and memory storing instructions that, when executed by the processor, cause the clustering service to: receive a plurality of geographical coordinates for a plurality of nodes, the plurality of geographical coordinates including, for each node of the plurality of nodes, geographical coordinates corresponding to a location of the node: receive a plurality of fulfillment features for the plurality of nodes, the plurality of fulfillment features including fulfillment features for each node of the plurality of nodes; and group, based on the plurality of geographical coordinates and the plurality of fulfillment features, the plurality of nodes into a plurality of clusters, each of the plurality of clusters including one or more nodes of the plurality of nodes: wherein grouping, based on the plurality of geographical coordinates and the plurality of fulfillment features, the plurality of nodes into the plurality of clusters comprises: based on one of the plurality of geographical coordinates or the plurality of fulfillment features, grouping the plurality of nodes into a plurality of general clusters; and determining a plurality of subclusters by, for each general cluster of the plurality of general clusters, grouping, based on one of the plurality of geographical coordinates or the plurality of fulfillment features, one or more nodes of the general cluster into one or more subclusters.

In another aspect, a non-transitory computer readable medium with instructions thereon is disclosed. The instructions, when executed by a processor, cause the processor to receive a plurality of geographical coordinates for a plurality of nodes, the plurality of geographical coordinates including, for each node of the plurality of nodes, geographical coordinates corresponding to a location of the node: receive a plurality of fulfillment features for the plurality of nodes, the plurality of fulfillment features including fulfillment features for each node of the plurality of nodes; and group, based on the plurality of geographical coordinates and the plurality of fulfillment features, the plurality of nodes into a plurality of clusters, each of the plurality of clusters including one or more nodes of the plurality of nodes; wherein grouping, based on the plurality of geographical coordinates and the plurality of fulfillment features, the plurality of nodes into the plurality of clusters comprises: based on one of the plurality of geographical coordinates or the plurality of fulfillment features, grouping the plurality of nodes into a plurality of general clusters; and determining a plurality of subclusters by, for each general cluster of the plurality of general clusters, grouping, based on one of the plurality of geographical coordinates or the plurality of fulfillment features, one or more nodes of the general cluster into one or more subclusters.

### BRIEF DESCRIPTION OF THE DRAWINGS

FIG. 1 illustrates an example network environment in which aspects of the present disclosure may be implemented.

FIG. 2 illustrates a schematic block diagram of aspects of the present disclosure.

FIG. 3 is a flowchart of an example method executable by a clustering service.

FIG. 4 illustrates a schematic diagram illustrating an example execution of aspects of a method disclosed herein.

FIG. 5 illustrates a schematic diagram illustrating an example execution of aspects of a method disclosed herein.

FIG. 6 is a flowchart of an example method for updating clusters.

FIG. 7 illustrates a schematic block diagram of aspects of the present disclosure.

FIG. 8 illustrates a schematic block diagram of aspects of the present disclosure.

FIG. 9 is a flowchart of an example method executable by a fulfillment service.

FIG. 10 illustrates a schematic block diagram of aspects of the present disclosure.

FIG. 11 illustrates aspects of an example user interface.

FIG. 12 illustrates a block diagram of an example computing system.

### DETAILED DESCRIPTION

As briefly described above, aspects of the present disclosure are directed to methods and systems for grouping nodes of a supply chain. A supply chain may include a plurality of layers, each of which may include a plurality of nodes. A node may be any location of a supply chain through which an item may pass. As an item moves from a first layer of the supply chain to a second layer of the supply chain, the item may move from an origin node of the first layer to a destination node of the second layer. In some instances, an enterprise may be responsible for handling the flow of items from one layer to the next, a responsibility that may include, among other things, determining inventory levels across nodes, determining delivery times, determining delivery logistics, and selecting an origin node from which to send an item.

In example aspects, a clustering service may group nodes of a layer into clusters. The clustering service may then provide these clusters to fulfillment services, such as services that determine item availability, determine delivery times, or that otherwise perform supply chain-related operations. The clustering service may group nodes based on both geographical proximity and fulfillment features. In one example, the clustering service may first form general clusters based on geographical proximity and then, for the nodes of each general cluster, form subclusters based on the similarity of fulfillment features of the nodes. In another example, the clustering service may do the reverse: first, the clustering service may form general clusters based on the similarity of fulfillment features and then, for each general cluster, form subclusters based on geographical proximity of the nodes. In some examples, the output of either approach is a set of clusters, each of which includes of one or more nodes. In some instances, the inventory for a cluster may be aggregated across nodes of the cluster to provide cluster-level item inventory.

In example aspects, the clustering service may, to form clusters based on geographical proximity, apply a machine learning algorithm to geographical coordinates of the nodes. To form clusters based on similarity of fulfillment features, the clustering service may compare the similarity of fulfillment features across nodes. Fulfillment features may be any characteristics of a node related to supply chain operations, such as features related to receiving, processing, or sending an item. Some example fulfillment features for a node include the following: the node's time zone: the latest time that a carrier may pick up an item at the node; a daily cutoff time for a node to internally process an order: a historical time in transit for items shipped from the node: carrier schedules; and whether a node offers a particular shipping service.

In example aspects, the clustering service may update clusters. For example, the clustering service may update clusters a few times a day, accounting for any new or removed nodes, and accounting for any changes to a node's fulfillment features. Furthermore, the clustering service may alter how clusters are defined (e.g., by changing how many clusters are formed, by assigning relative weights to fulfillment features, by adding or removing fulfillment features, or by changing how clusters are formed based on geographic proximity). Yet still, an administrator may customize one or more particular clusters (e.g., forcing two or more nodes to be in a cluster, even if they otherwise would not be clustered).

Certain embodiments of the present disclosure have technical features that make them particularly advantageous over existing tools. One advantage is that the time required for supply chain-related computing operations may be reduced. For example, a fulfillment service may interact with records associated with clusters to perform one or more fulfillment tasks (e.g., coordinating the flow of items from node to node, checking item availability, estimating delivery times, etc.). A fulfillment service may initiate one data request as associated with a cluster, rather than performing the data request with respect to each of the nodes that make up the cluster. For example, an analysis of item availability within a particular timeframe may be analyzed with respect to an aggregated cluster of similarly situated retail locations, rather than analyzing item availability and shipment features of each retail location individually. This can reduce the number of operations that a fulfillment service is required to perform, and improve the speed at which the fulfillment service may analyze and execute a fulfillment task. As a result, the latency time required to perform a fulfillment task may be reduced. More generally, by improving the efficiency at which a computing task (e.g., a computer-implemented fulfillment task) is performed, aspects of the present disclosure may result in reduced computational load, reduced chip temperature, reduced chip size, reduced power consumption, faster speeds, and improved reliability.

Another advantage is that computer memory storage space is saved. For example, a fulfillment service need not use memory for data related to each node that makes up a cluster, but rather may use memory for a cluster that aggregates data from its constituent nodes. By improving the computational speed at which a fulfillment service may interact with supply chain nodes, and by reducing the memory load required to do so, aspects of the present disclosure may also enable a fulfillment service to interact with more nodes-which may improve overall supply chain operations and decisions-without consuming more computing resources.

Yet another advantage may be that computing costs are shifted from the time of fulfillment to the time of forming clusters, with less computation required in real time during fulfillment. Such forward caching may be useful for an enterprise that experiences large fluctuations in how much computing is required (e.g., an enterprise that receive spikes in computing needs during certain times of the day or periods of the year).

Yet another advantage of the present disclosure may be that clusters can be automatically updated. As a result, the clusters may dynamically adapt as nodes are added or removed or as fulfillment features are added, removed, or changed. Yet still, the configurability of clusters provides an enterprise with extensive flexibility regarding how clusters are implemented and defined. For example, an enterprise may select implementation features regarding how clusters are grouped by geographical proximity, and an enterprise may select which fulfillment features are considered and how clusters are grouped based similarities of fulfillment features. As a result, an enterprise may define clusters in a way that improves business metrics (e.g., percentage of on-time deliveries, throughput, shipping costs, etc.) for that enterprise. As will be apparent, these are only some of the advantages offered by aspects of the present disclosure.

Although some aspects of the present disclosure are described in the context of a retail supply chain and with respect to a retail enterprise, the present disclosure is not limited to such examples. For example, a carrier enterprise (e.g., a distribution company, a trucking company, or another company that facilitates the transportation of items) may also use aspects of the present disclosure. Additionally, aspects of the present disclosure may also be implemented in other industries and enterprises that manage or outsource supply chain operations.

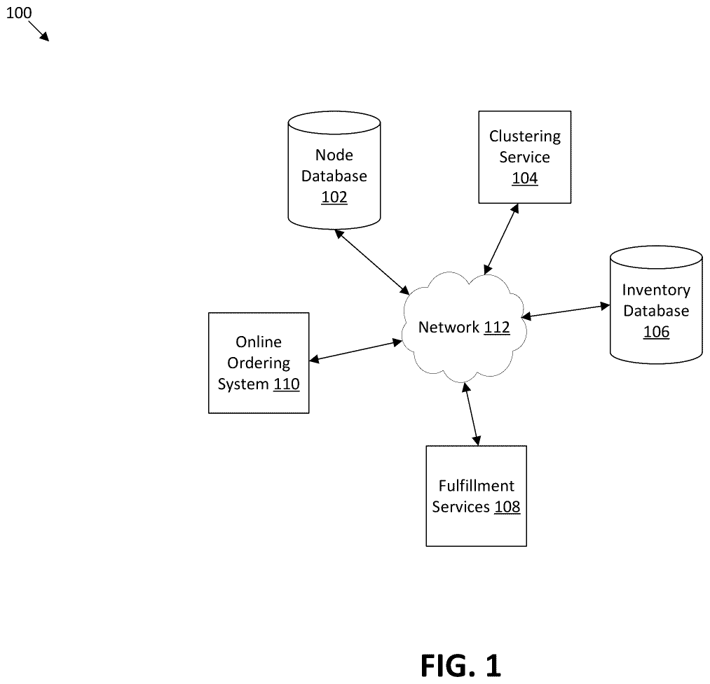

FIG. 1 illustrates an example network environment 100 in which aspects of the present disclosure may be implemented. In the example of FIG. 1, the environment 100 includes a plurality of components. The environment 100 incudes a node database 102, clustering service 104, inventory database 106, fulfillment services 108, and an online ordering system 110. As shown in the example of FIG. 1, one or more components of the environment 100 may be communicatively coupled via a network 112. In some embodiments, each of the components of the environment 100 may include software, hardware, and a combination of software and hardware. In some embodiments, one or more of the databases 102 or 106 may include data that is distributed across multiple databases, and in some embodiments, the databases 102 and 106 may include data that overlaps in a common database.

The node database 102 may include node data for a plurality of nodes in a supply chain. The supply chain may include, for example, locations, items, transportation means, and other components. In some examples, the supply chain may include a plurality of layers through which an item may pass as it is transported through the supply chain. In some examples, each of the layers of a supply chain may include one or more nodes. In some embodiments, a node may be any location of a supply chain in which an item may be received, stored, or processed, or from which an item may be sent. In some examples, a node may be one or more of a retail store, a fulfillment center, a distribution center, a warehouse, a sortation center, or a destination. In some embodiments, a majority (e.g., more than fifty percent) of nodes associated with the node data may be retail stores. Depending on the supply chain, a fulfillment center may include a distribution center, warehouse, or sortation center. In some instances, a fulfillment center may be a third-party location, such as a supply chain location associated with a vendor or carrier.

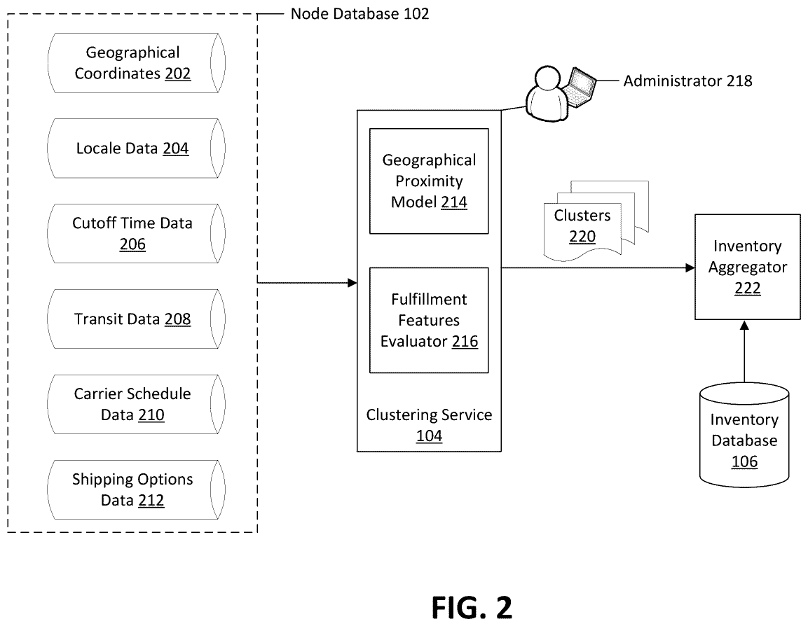

For each of a plurality of nodes, the node database may include node data. Among other things, the node data may include geographical coordinates corresponding to a location of the node, and the node data may include fulfillment features of a node, which may relate to characteristics of a node related to supply chain operations. Fulfillment features for a node may include data related to receiving, processing, or sending an item at the node, or a timing at which supply chain operations are performed at the node. In some embodiments, the node database 102 may receive data from one or more of the other components of FIG. 1 (e.g., from the fulfillment services 108 or from the online ordering system 110). In some embodiments, the node database 102 may receive node data from another system or from an administrator of node data. Examples of node data are further described below in connection with FIG. 2.

The clustering service 104 may receive node data (e.g., from the node database 102) and virtually group nodes into one or more clusters. Each cluster may include one or more nodes that are geographically near one another and that are similar from a fulfilment perspective. In some embodiments, nodes that are geographically near or proximate to one another may be within a certain distance from one another (e.g., 10, 50, or 100 miles). The distance may be defined, for example, based on the number of nodes or clusters. In some embodiments, nodes that are geographically near or proximate to one another may have a sufficiently small distance between them, such that a clustering algorithm (e.g., K-Means or DBSCAN) places them in a common cluster based on, for example, the number of nodes, the locations of nodes, and other parameters included in an execution of the algorithm. In some embodiments, nodes of a common cluster may offer similar shipping services, be associated with similar transit times for items, have similar cutoff times for item delivery and processing, be associated with similar carriers, be in a same time zone, or otherwise have features in common that relate to the process or timing of receiving, processing, or sending items. In some embodiments, the clustering service 104 may provide clusters to one or more fulfillment services of the fulfillment services 108. The clustering service 104 is further described below in connection with FIGS. 2-6.

The inventory database 106 may include inventory data for items in a supply chain. In some embodiments, the supply chain may correspond with the supply chain associated with the node data of the node database 102. In some embodiments, the inventory database 106 may receive inventory data—and updates to inventory data—from one or more components of the environment 100 or from another system. The inventory data may include a plurality of items. For each item, the inventory data may include data related to allocation of that item across nodes. The inventory data may include an amount of the item at one or more nodes, an amount of the item that is available, a demand for the item, an amount of the item that is promised, or characteristics of an item, such as price, description, features, or other characteristics. In some embodiments, inventory data may be combined with clusters from the clustering service 104 to determine cluster-level item availability, as is further described below in connection with FIG. 2. In some embodiments, the inventory database 106 may provide inventory data, which may include cluster-level item availability, to other components of the environment 100, such as the clustering service 104, a fulfillment service of the fulfillment services 108 or the online ordering system 110.

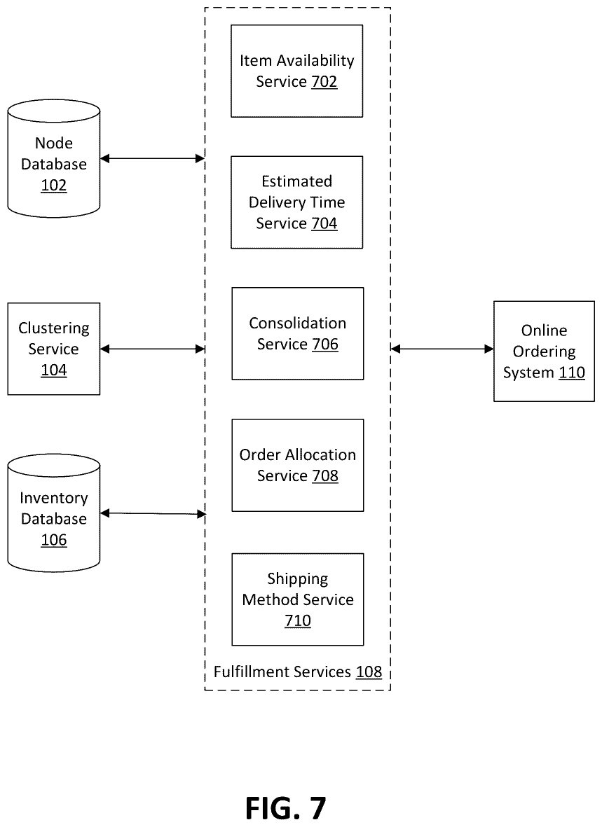

The fulfillment services 108 may include a plurality of fulfillment services, one or more of which may perform a task related to moving items through a supply chain or to fulfilling orders. Example tasks include determining item availability, determining delivery times, consolidating items or orders, evaluating or selecting a transportation means, allocating an order to one or more nodes, or other supply chain-related operations. In some embodiments, the fulfillment services 108 may receive data from one or more of the other components of the environment 100. For example, the fulfillment services 108 may receive node data from the node database 102, clusters from the clustering service 104, inventory data from the inventory database 106, requests or orders from the online ordering system 110, and other data. In some embodiments, one or more of the fulfillment services 108 may also provide data to other components of the environment 100. Aspects of the fulfillment services 108 are further described below in connection with FIGS. 7-10.

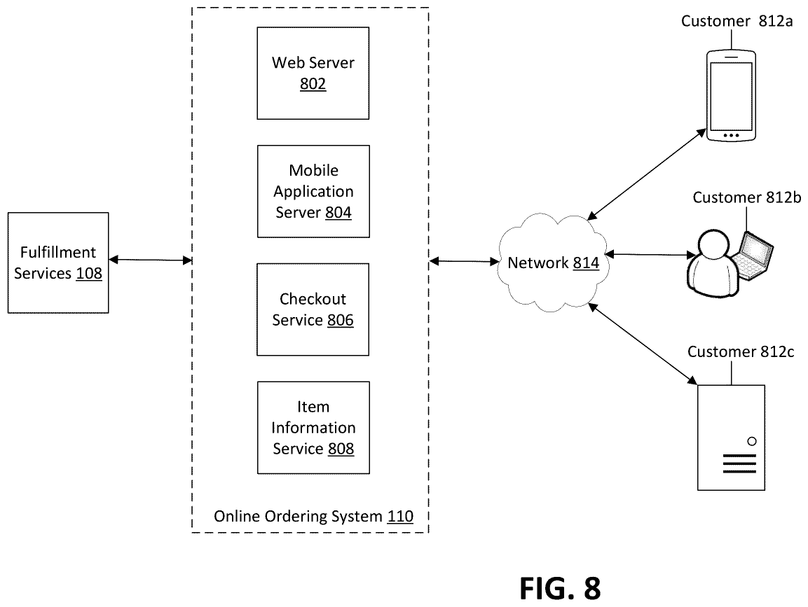

The online ordering system 110 may include, or be communicatively coupled with, components related to interacting with customers. Example components of the online ordering system may include a web server, a mobile application server, a service for retrieving or displaying items, or a service for receiving or processing orders. An order may include one or more items that may move through a supply chain and one or more destinations for those items. A destination may be, for example, another node in the supply chain (e.g., a retail store, a fulfillment center, a sortation center, a third-party location), a customer location (e.g., residence or business location), a ZIP code, or another location related to where items of the order are to be sent. In some embodiments, a component of the online ordering system 110 may call one or more of the fulfillment services 108 to perform a fulfillment a task, such as determining an item availability, determining an estimated delivery date, or allocating an order. In some embodiments, the online ordering system 110 may provide data to other components of the environment 100. Aspects of the online ordering system 110 are further described below in connection with FIG. 8.

The network 112 may be, for example, a wireless network, a wired network, a virtual network, the internet, or another type of network. Furthermore, the network 112 may be divided into subnetworks, and the subnetworks may be different types of networks or the same type of network. In different embodiments, the network environment 100 can include a different network configuration than shown in FIG. 1, and the network environment 100 may include more or fewer components than those illustrated.

FIG. 2 illustrates a schematic block diagram of aspects of the present disclosure. The example of FIG. 2 includes the node database 102, the clustering service 104, and the inventory database 106, each of which is illustrated and described above in connection with FIG. 1. Furthermore, components of FIG. 2 may, in some embodiments, communicate via the network 112 of FIG. 1. In the example of FIG. 2, the node database 102 includes examples of node data 202-212, which includes geographical coordinates 202, locale data 204, cutoff time data 206, transit data 208, carrier schedule data 210, and shipping options data 212. As shown, the node database 102 may provide the node data 202-212 to the clustering service 104.

Generally describing the node data 202-212, the node data 202-212 may be for a plurality of nodes of a supply chain, and the node data 202-212 may be separated by node. Thus, although aspects of the present disclosure discuss the node data 202-212 as applying to a particular node, the node data 202-212 may include data for a plurality of nodes. In some instances, some of the node data 202-212 may be the same for some nodes (e.g., two or more nodes may have the same locale data or cutoff time data). In some instances, some of the node data 202-212 may be unique for each node (e.g., each node of a plurality of nodes may have unique geographical coordinates). In some embodiments, the node data 202-212 may be grouped. For example, the node data 204-212 may be grouped as fulfillment features, whereas the geographical coordinates 202 may, either alone or in combination with other data, be grouped as geographical coordinates.

The geographical coordinates 202 may include values corresponding to a location of a node. For example, the geographical coordinates 202 may correspond to a physical location associated with the node. If, for example, the node is a store, then the geographical coordinates 202 may indicate where the store is geographically located. In some embodiments, the geographical coordinates 202 may include latitude and longitude values for the node. In some embodiments, the geographical coordinates 202 may include other values that correspond to a location of the node, such as codes or numbers that describe a geographical location. In some embodiments, the geographical coordinates 202 may also include data related to distances between nodes of a plurality of nodes (e.g., a two-dimensional matrix with values indicating a distance between two or more nodes).

The locale data 204 for a node may include data related to the location of a node. In some embodiments, locale data 204 for a node may be derived from or may include the geographical coordinates 202 of the node. In other embodiments, however, the locale data 204 may be separate from the geographical coordinates 202 of the node. The locale data 204 for a node may include one or more of the time zone, state, region, country, or zip code in which the node is located.

The cutoff time data 206 for a node may include one or more times related to processing items at the node. A node may be associated with a plurality of cutoff times. For example, a node may include one or more carrier cutoff times and one or more item processing cutoff times. In some instances, the cutoff time may vary depending on the day of the week.

The one or more carrier cutoff times may include the latest time by which a carrier may pick up an item from the node. In some instances, such cutoff times may vary depending on the carrier. A carrier may be, for example, a company that transports items from one location to the next, or the carrier may, in some instances, be a gig worker. As an example, a node may have a daily cutoff time of 4:00 PM for Carrier A to pickup items, but the node may have a daily cutoff time of 4:30 PM for Carrier B to pick up items. Furthermore, in some instances, the carrier cutoff times may vary depending on the shipment service, which may include different services such as standard shipping, two-day shipping, or priority shipping. As an example, a node may have a cutoff time of 4:00 PM for standard shipping, but the node may have a cutoff time of 7:00 PM for priority shipping. Yet still, in some embodiments, carrier cutoff times for a node may vary depending on both the carrier and the shipment service. As an example, a node may have a carrier cutoff time of 4:00 PM for standard shipping offered by Carrier A, a carrier cutoff time of 6:30 PM for two-day shipping offered by Carrier A, and a carrier cutoff time of 5:00 PM for standard shipping offered by Carrier B. Both carrier cutoff time values and types of carrier cutoff times may vary from node to node in some embodiments.

The one or more internal processing cutoff times for a node may include the latest time by which the node may receive a request or order and process the request or order on that day. For instance, if an internal processing cutoff time is 12:00 PM, then if the node receives a request or order by 12:00 PM, then the node will process items associated with the order (e.g., by picking, packing, moving, or performing another action) on the same day that the request or order is received. In some embodiments, a node may be associated with a plurality of internal processing times. For example, the internal processing time may—similar to the carrier cutoff times—vary depending on one or more of the carrier associated with an order or the shipment service associated with the order.

The transit data 208 for a node may include transit data for items sent from the node. In some embodiments, the transit data 208 may include, or be derived from, historical data related to item shipments from the node. For example, the transit data 208 may indicate that, on average, an item takes a certain number of days or hours from the time that it leaves the node to the time that it reaches a destination node. In some embodiments, the transit data 208 may be broken down by one or more of carrier or service. For example, the transit data 208 may indicate that, from the node, an item takes on average three days to arrive to a destination node when transported by Carrier A with standard shipping, two-and-a-half days to arrive to the destination node when transported by Carrier A with two-day shipping, and four days to arrive to the destination node when transported by Carrier B with standard shipping. In some embodiments, the transit data 208 may be further broken down by other characteristics, such as item type, or by the time of day, week, or year.

The carrier schedule data 210 for a node may include data related to carriers associated with the node. For example, the carrier schedule data 210 may include a plurality of schedules for a plurality of carriers. Each of the schedules may include the days that the carrier does—or does not—work with the node, and each of the schedules may include times that the carrier operates. Furthermore, the carrier schedules may include the nodes with which the carrier works (e.g., a carrier schedule may indicate that a particular carrier only delivers items to and from certain nodes). In some embodiments, a carrier schedule may also include values broken down by a service, such as standard, two-day, or priority shipping. Furthermore, data of a carrier schedule may be broken down by whether it is for pickup or for delivery.

The shipping options data 212 for a node may include shipping options offered by the node. For example, the shipping options data 212 may indicate whether the node offers a certain shipping service, such as two-day delivery, same-day delivery, a service for driving to a location to pick up an item, a service to walk into a location to pick up an item, or other possible service that may be offered by a node.

As described above in connection with FIG. 1, the node database 102 may provide node data to the clustering service 104. In some embodiments, the node database 102 may provide node data to the clustering service 104 in response to a request from the clustering service 104. In some embodiments, the node database 102 may automatically provide node data to the clustering service 104. In some instances, the node database 102 may provide updated node data to the clustering service (e.g., in response to an update to any of the node data 202-212).

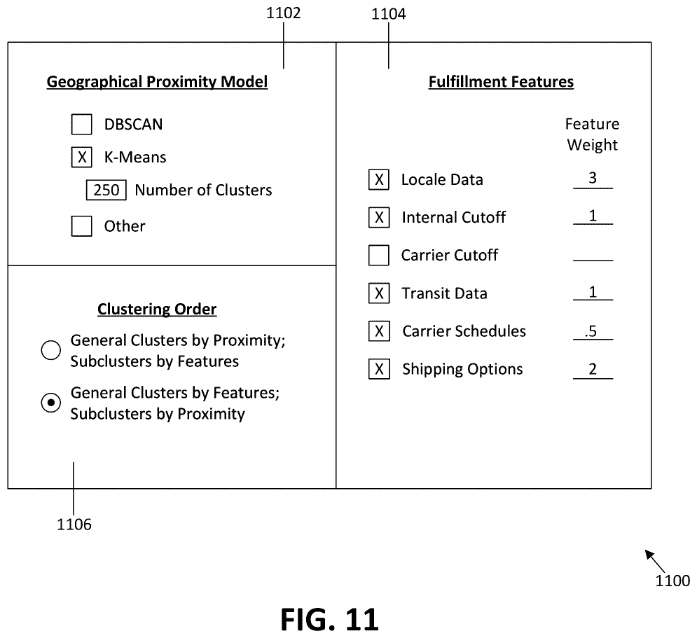

The clustering service 104 may receive node data and, based on the node data, group records associated with a plurality of nodes into a plurality of clusters, such as the clusters 220. In some embodiments, the clustering service 104 may—in order to group nodes into clusters—group nodes into general clusters and then group nodes of the general clusters into subclusters. In some embodiments, the clusters 220 may be the resultant subclusters. For example, each of the clusters 220 may be a collection of data records associated with the nodes that form the cluster. In the example of FIG. 2, the clustering service 104 includes a geographical proximity model 214 and a fulfillment features evaluator 216. In some embodiments, the clustering service 104 may first apply the geographical proximity model 214 to form general clusters and then apply the fulfillment features evaluator 216 to form subclusters. In some embodiments, the clustering service 104 may first apply the fulfillment features evaluator 216 to form general clusters and then apply the geographical proximity model 214 to form subclusters. In some embodiments, the clustering service 104 may also include other components, such as a user interface (example aspects of which are illustrated and described below in connection with FIG. 11), a cache or database for storing node data or cluster data, or other components. In the example of FIG. 2, the clustering service 104 is associated with an administrator 218.

In some embodiments, the geographical proximity model 214 may receive geographical coordinates for a plurality of nodes. For example, the geographical proximity model 214 may receive geographical coordinates 202 from the node database 102. In some embodiments, the geographical proximity model 214 may use the geographical coordinates to generate and output a plurality of location-based clusters.

In some embodiments, the geographical proximity model 214 may determine a distance between two or more of the plurality of nodes. To do so, the geographical proximity model 214 may, in some embodiments, use the Haversine distance or the Euclidean distance. In some embodiments, the geographical proximity model 214 may implement a machine learning algorithm to group nodes. For example, the geographical proximity model 214 may use K-Means Clustering. When using K-Means Clustering, the administrator 218 may input a number of clusters to form. In some embodiments, the geographical proximity model 214 may use density-based spatial clustering of applications with noise (DBSCAN), and the administrator 218 may input DBSCAN parameters, such as an epsilon value and a minimum points value. In some embodiments, the geographical proximity model 214 may use a combination of techniques or algorithms as part of generating location-based clusters.

As a result of an execution of a machine learning algorithm, the geographical proximity model 214 may generate a plurality of clusters that include nodes that are near one another. In some embodiments, nodes that are geographically near or proximate to one another may be within a certain distance from one another (e.g., 10, 50, or 100 miles). The distance may be defined, for example, based on the number of nodes or clusters, or by an administrator. In some embodiments, nodes that are geographically near or proximate to one another may have a sufficiently small distance between them, such that a clustering algorithm (e.g., K-Means or DBSCAN) places them in a common cluster based on, for example, the number of nodes, the locations of nodes, and other parameters included in an execution of the clustering algorithm.

In some embodiments, the fulfillment features evaluator 216 may receive a plurality of fulfillment features for a plurality of nodes. The fulfillment features may include, for example, the node data 204-212. The fulfillment features for a node may include any characteristics of a node related to supply chain operations, such as characteristics related to receiving, processing, or sending an item, or a timing at which supply chain operations are performed. For example, the fulfillment features evaluator 216 may receive locale data 204, cutoff time data 206, transit data 208, carrier schedule data 210, and shipping options data 212.

In some embodiments, the fulfillment features evaluator 216 may output a plurality of clusters of nodes based on the fulfillment features. In some embodiments, each of the clusters may include one or more nodes of the plurality of nodes that have the same—or similar—values for the plurality of fulfillment features. As an example, the nodes of a cluster may have the same or similar values for locale data (e.g., the same time zone), cutoff time data, transit data, carrier schedule data, and shipping options data. In some embodiments, the fulfillment features evaluator 216 may consider only a subset of possible fulfillment features when forming clusters.

In some embodiments, the fulfillment features evaluator 216 may only cluster together two or more nodes if they have the same fulfillment features. In other embodiments, the fulfillment features evaluator 216 may cluster nodes together if they have less than a certain number (e.g., two or another number definable by the administrator 218) of fulfillment feature differences. For example, a cluster may include nodes that have similar order fulfillment features, even if one or more of the order fulfillment features differ. For example, a cluster may include two nodes that have slight differences in cutoff times but that otherwise have the same fulfillment features. In some embodiments, the fulfillment features evaluator 216 may weigh fulfillment features by importance (e.g., features related to shipping options or locale may be assigned a relatively higher weight than some cutoff times).

In some embodiments, the fulfillment features evaluator 216 may generate a score for fulfillment feature similarity for a pair of nodes, where a higher score indicates a greater degree of similarity in fulfillment features and a lower score indicates a lower degree of fulfillment feature similarity. In some embodiments, the fulfillment features evaluator 216 may use fulfillment feature weights as part of generating a similarity score for two nodes. In some embodiments, the fulfillment features evaluator 216 may generate a plurality of scores for the plurality of nodes and may cluster nodes having relatively high similarity scores (e.g., as compared to other scores). By using feature weights, the fulfillment features evaluator 216 may, in some embodiments, cause nodes having similar, highly weighted features to be clustered, even if the nodes have dissimilar features that have relatively low weights. In some embodiments, the fulfillment features evaluator 216 may be implemented using a script that automatically parses node data and that clusters nodes.

In some embodiments, the administrator 218 may alter aspects of the clustering service 104. For example, the administrator 218 may, in some embodiments, perform one or more of the following operations: define a number of clusters to be formed; override a clustering to ensure that two or more nodes are clustered together or separately; assign weights to fulfillment features; select or deselect fulfillment features; set a cluster update time interval that indicates the frequency at which the clustering service 104 updates clusters; provide node data; couple the clustering service 104 with a node database; input one or more parameters for use by the geographical proximity model; or perform another operation. In some embodiments, the administrator 218 may interact with a user interface associated with the clustering service 104. Aspects of an example user interface are illustrated and described below in connection with FIG. 11.

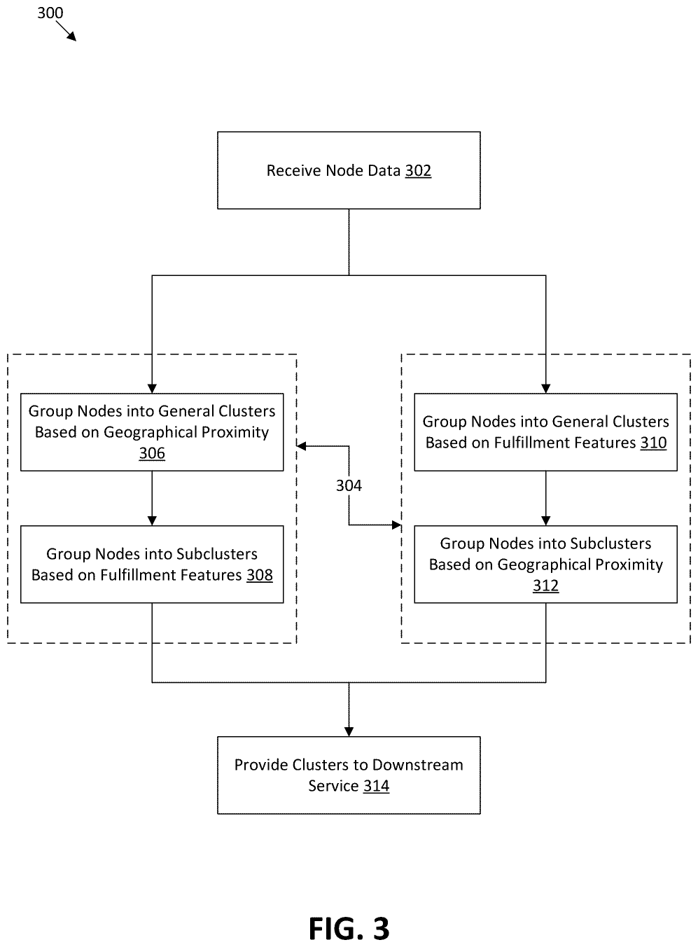

Example operations of the clustering service 104, the geographical proximity model 214, and the fulfillment features evaluator 216 are further described below in connection with FIGS. 3-6.

As illustrated by the example of FIG. 2, the clustering service 104 may output clusters 220. Each cluster of the clusters 220 may be a virtual grouping of nodes. Each cluster of the clusters 220 may include data generated by the clustering service 104 as well as data related to the nodes that make up the cluster. The clusters 220 may be output in the form of a data stream or one or more data files. The clustering service 104 may output the clusters 220 to another system, such as a fulfillment service of the fulfillment services 108 or to an inventory aggregator 222.

In some embodiments, the inventory aggregator 222 is part of or associated with one or more of the fulfillment services 108. In some embodiments, the inventory aggregator 222 may receive the clusters 220 from the clustering service 104 and inventory data from the inventory database 106. In some embodiments, inventory data may include item-specific inventory data broken down by node. The inventory aggregator 222 may use the clusters 220 and the inventory data to generate cluster-level inventory data for each of the plurality of clusters 220. For a cluster, the cluster-level inventory data may be an aggregate of the inventory data for each of the nodes belonging to the cluster. In some embodiments, the cluster-level inventory data for a cluster may include a cluster-level item availability (e.g., a quantity of an item that is available across a cluster's constituent nodes), a cluster-level item demand amount, an indication of whether an item is available in at least one node of a cluster, and other inventory data that may be associated with a node and aggregated across a plurality of nodes. In some embodiments, as inventory data for a node changes, cluster-level inventory data for a cluster including the node may change accordingly (e.g., if the inventory of an item at a node decreases, the aggregate inventory of that item at the cluster level will also decrease).

FIG. 3 is a flowchart of an example method 300. In some embodiments, the method 300 may be performed by the clustering service 104 or components of the clustering service 104.

In the example shown, the clustering service 104 may receive node data (step 302). For example, the clustering service 104 may receive node data for a plurality of nodes of a supply chain. In some embodiments, the clustering service 104 may receive node data 202-212 from the node database 102. In some embodiments, the clustering service 104 may receive node data from a plurality of sources. In some embodiments, receiving node data may include receiving updates to node data previously received by the clustering service 104. In such cases, the clustering service 104 may have previous node data stored and may update the stored data with the updated data. In some embodiments, the node data may include a plurality of geographical coordinates for a plurality of nodes and a plurality of fulfillment features for the plurality of nodes.

In the example shown, the clustering service 104 may group the plurality of nodes of nodes into a plurality of clusters based on the geographical coordinates and the fulfillment features (step 304). In some embodiments, the clustering service 104 may perform two clustering processes to cluster the nodes. For example, the clustering service 104 may first group nodes into general clusters and then group the nodes into subclusters. As an example, the clustering service 104 may generate, for example, ten to fifty general clusters, and the nodes from each of the general clusters may be clustered into, for example, two to twenty subclusters, resulting, for example, in between twenty and one thousand clusters that may be provided to another service. In some embodiments, a single node may be a cluster: in other embodiments, a cluster includes two or more nodes.

The method 300 illustrates two example operation sets for performing the step 304. A first example is illustrated as the steps 306-308. A second example is illustrated as the steps 310-312. In some embodiments, the clustering service 104 may perform the steps 306-308. In some embodiments, the clustering service 104 may perform the steps 310-312. In some embodiments, the clustering service 104 may perform one of the steps 306-308 or the steps 310-312 based, for example, on a configurable administrator selection of how to form clusters or based on characteristics of the plurality of nodes.

Referring now to the steps 306-308, the clustering service 104 may group nodes of the plurality of nodes into general clusters based on geographical proximity (step 306). For example, the clustering service 104 may, in some embodiments, apply the geographical proximity model 214, which is further described above in connection with FIG. 2, to the plurality of geographical coordinates of the plurality of nodes (or to distances derived from the geographical coordinates), resulting in a plurality of location-based general clusters. Each of these location-based general clusters may include one or more nodes.

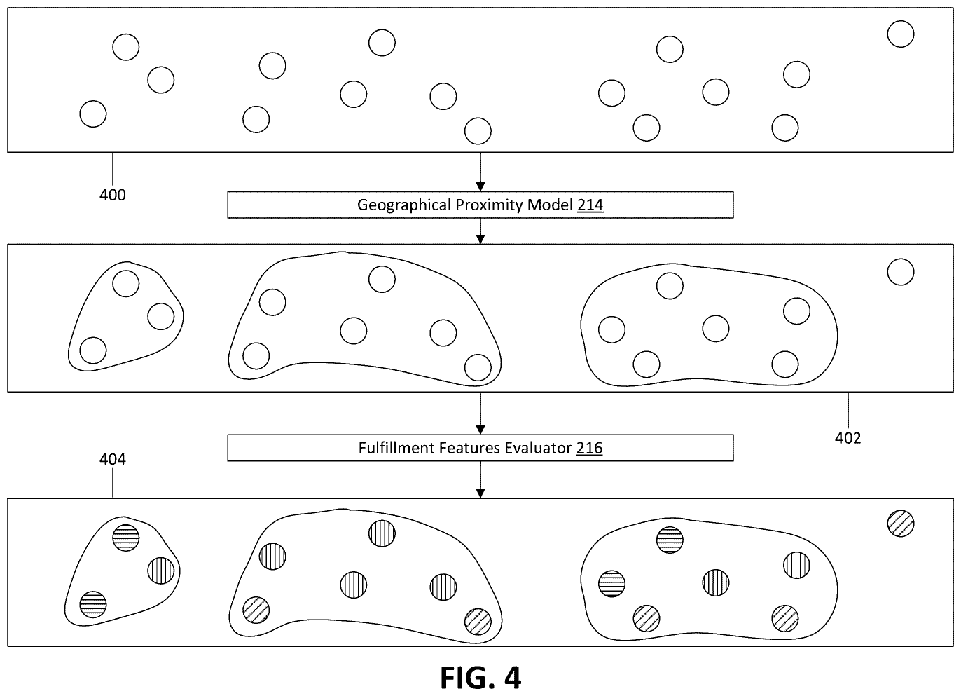

In the example shown, clustering service 104 may group nodes into subclusters based on fulfillment features (step 308). In some embodiments, the clustering service 104 may, for each general cluster generated at the step 306, separate the nodes of the general cluster into subclusters based on the similarity of fulfillment features. In some embodiments, the clustering service 104 may apply the fulfillment features evaluator 216, which is further described above in connection with FIG. 2, to the one or more nodes of a general cluster to form subclusters. As a result, each of the subclusters may include nodes that are not only similar to one another with respect to order fulfillment features but also geographically near one another. An example of the steps 306-308 is illustrated and described below in connection with FIG. 4.

Referring now to the steps 310-312, the clustering service 104 may group nodes of the plurality nodes into general clusters based on the similarity of fulfillment features of the nodes (step 310). In some embodiments, the clustering service 104 may apply the fulfillment features evaluator 216, which is further described above in connection with FIG. 2, to the fulfillment features of the plurality of nodes, resulting in general clusters having nodes that may have similar fulfillment features, but that may not be geographically near one another.

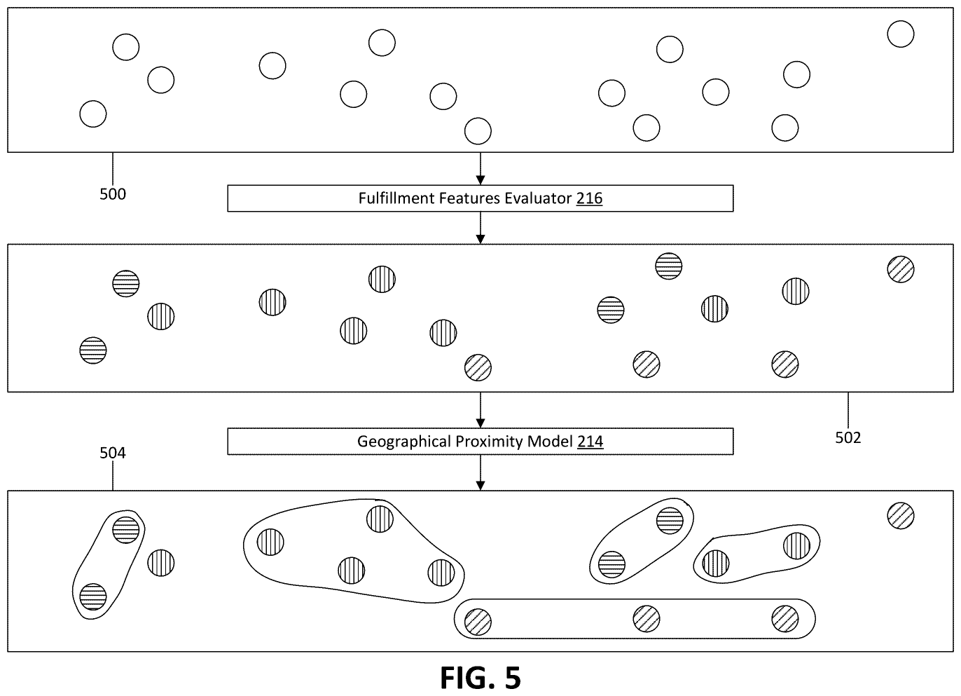

In the example shown, the clustering service 104 may group nodes into subclusters based on geographical proximity (step 312). In some embodiments, the clustering service 104 may, for each general cluster generated at the step 310, separate the nodes of the general cluster into subclusters based on the geographical proximity of the nodes. In some embodiments, the clustering service 104 may apply the geographical proximity model 214, which is further described above in connection with FIG. 2, to the one or more nodes of a general cluster to form subclusters. As a result, each of the subclusters may include nodes that are not only similar to one another with respect to order fulfillment features but also geographically near one another. An example of the steps 310-312 is illustrated and described below in connection with FIG. 5.

In the example shown, the clustering service 104 may provide clusters to a downstream service (step 314). In some embodiments, each of the clusters is data that identifies the cluster's constituent nodes (e.g., each of the clusters may be a set of identifying alphanumeric characters associated with the cluster's constituent nodes). In some embodiments, each of the clusters is a set of data that may, for example, identify the cluster's constituent nodes, indicate characteristics of the cluster's constituent nodes (e.g., one or more geographical locations of the nodes or common fulfillment characteristics of the nodes), one or more other data records of the cluster's constituent nodes, metadata related to operations of the clustering service 104 when generating the cluster (e.g., a time at which the cluster was generated or a parameter used to generate a cluster), or other data generated by the clustering service 314. The clusters may be, for example, the subclusters generated at the step 308 or the step 312. In some embodiments, the downstream service may be one or more of the fulfillment services 108, the downstream service may be the inventory aggregator 222 (e.g., as described above in connection with the example of FIG. 2), or the downstream service may be another system that is configured to receive clusters from the clustering service 104.

Referring generally to FIGS. 4-5, schematic diagrams of operations of the clustering service 104 are illustrated. Although illustrated with 15 nodes, it should be understood that aspects of the present disclosure may be applied to nodes in a supply chain having, for example, hundreds, thousands, tens-of-thousands, or any number of nodes. Likewise, aspects of the present disclosure may, depending on the embodiment, be used to generate many more clusters (including general clusters and/or subclusters) than those shown in the examples of FIGS. 4-5.

FIG. 4 illustrates a schematic diagram of an example execution of aspects of the steps 306-308 of FIG. 3. The example of FIG. 4 includes the instances 400-404. Each of the instances 400-404 includes a plurality of nodes of a supply chain represented by circles. Each of the instances 400-404 may correspond with a state of virtual clustering with respect to the steps 306-308 (e.g., the instance 400 may correspond with a state of virtual clustering prior to grouping nodes into general clusters based on geographical proximity: the instance 402 may correspond with a state of virtual clustering after grouping nodes into general clusters based on geographical proximity; and the instance 404 may correspond with a state of virtual clustering after grouping nodes into subclusters based on fulfillment features).

In the instance 400, the nodes may not be clustered. In the example shown, the clustering service 104 may apply the geographical proximity model 214 to geographical coordinates associated with the plurality of nodes to generate general clusters, as illustrated by the groups of nodes in the instance 402. The instance 402 illustrates that the plurality of nodes are grouped into three clusters based on geographical proximity. In some embodiments, however, the instance 402 illustrates that the plurality of nodes are grouped into four clusters based on geographical proximity (e.g., in some embodiments, a single node may constitute a cluster).

In the example shown, the clustering service 104 may apply the fulfillment features evaluator 216 to fulfillment features for the plurality of nodes. In some embodiments, the fulfillment features evaluator 216 may, for each of the general clusters, group the nodes in the general cluster based on similarity of fulfillment features. In the example of FIG. 4, the nodes having similar fulfillment features are filled in with a similar pattern. For example, the fulfillment features evaluator 216 may have determined that the nodes filled in with horizontal lines are clustered together based on similar fulfillment features, that the nodes filled in with horizontal lines are clustered together based on similar fulfillment features, and that nodes with diagonal lines are clustered together based on similar fulfillment features. In some embodiments, however, two or more nodes may not be grouped together in a subcluster based on similarity of fulfillment features unless they also belong to the same location-based general cluster. For example, the clustering service 104 may apply the fulfillment features evaluator 216 for each of the general clusters. As illustrated by the instance 404, the clustering service 104 may have grouped the nodes into eight clusters, with nodes that are geographically proximate and that have similar fulfillment features being clustered together.

FIG. 5 illustrates a schematic diagram of an example execution of the steps 310-312. The example of FIG. 5 includes the instances 500-504. Each of the instances 500-504 includes a plurality of nodes of a supply chain represented by circles. Each of the instances 500-504 may correspond with a state of virtual clustering with respect to the steps 310-312 (e.g., the instance 500) may correspond with a state of virtual clustering prior to grouping nodes into general clusters based on fulfillment features: the instance 502 may correspond with a state of virtual clustering after grouping nodes into general clusters based on fulfillment features; and the instance 504 may correspond with a state of virtual clustering after grouping nodes into subclusters based on geographical proximity).

In the instance 500, the nodes may not be clustered. In the example shown, the clustering service 104 may apply the fulfillment features evaluator 216 to cluster the nodes based on similarity of fulfillment features. In the example shown, the instance 502 illustrates that the plurality of nodes are grouped into three general clusters based on similarity of fulfillment features (e.g., as illustrated by nodes having pattern of horizontal, vertical, and diagonal lines).

In the example shown, the clustering service 104 may apply the geographical proximity model 214 to the general clusters illustrated in the instance 502. For example, the clustering service 104 may, for each of the general clusters illustrated in the instance 502, divide the nodes into subclusters based on geographical proximity, resulting in the subclusters illustrated in the instance 504. As illustrated by the example instance 504, the clustering service 104 may have grouped the nodes into seven clusters, with nodes that are geographically proximate and that have similar fulfillment features being clustered together.

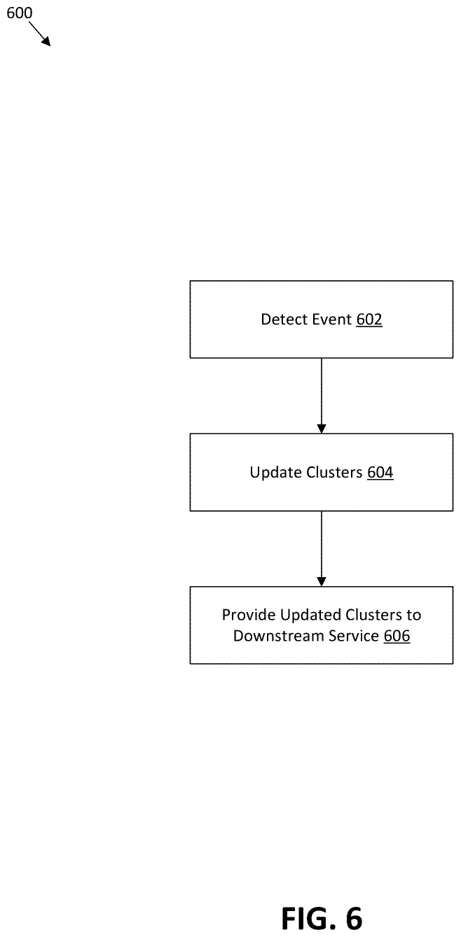

FIG. 6 is a flowchart of an example method 600 for updating clusters. In some embodiments, the method 600 may be executable by the clustering service 104. In some instances, the clustering service 104 may, by automatically updating clusters in response to detecting events, dynamically adjust clusters to account for supply chain changes (e.g., addition or removal of nodes), fulfillment feature changes (e.g., node-level changes), and administrator-initiated changes.

In the example shown, the clustering service 104 may detect an event (step 602). In some embodiments, an event may be a change to node data. For example, a node may have been added to or removed from the node data. As another example, values for one or more aspects of the node data may have changed. For instance, one or more fulfillment features for a node may have changed (e.g., a change to a cutoff time, a change to a carrier schedule, an update to transit data, or a change to shipping options offered by a node). Another example event may be a user input requesting that the clustering service 104 update clusters. Another example event may be a passage of a predetermined amount of time. For example, the clustering service 104 may be configured to update clusters at predetermined times of the day or after an elapse of a predetermined amount of time. In some embodiments, an administrator may define or select events that cause the clustering service 104 to update clusters.

In the example shown, the clustering service 104 may update clusters (step 604). In some embodiments, the clustering service 104 may apply aspects of the method 300 when updating clusters. For example, the clustering service 104 may receive node data and generate clusters based on geographical coordinates and fulfillment features of the nodes. In some embodiments, the clustering service 104 may automatically receive updated node data when an event occurs. In some embodiments, the clustering service 104 may request node data from the node database 102 in response to detecting an event. In some embodiments, the clustering service 104 may only receive data that has been updated. In such embodiments, the clustering service 104 may retrieve data that has not been updated from a cache or local database. In some embodiments, the clustering service 104 may only update clusters for which there has been a change to data of the nodes that make up the cluster. In some instances, as a result of updating clusters, there may be more or fewer clusters, the collection of nodes of one or more clusters may be altered, or node data of constituent nodes may be altered.

In the example shown, the clustering service 104 may provide updated clusters to a downstream service (step 606). For example, the clustering service 104 may provide the updated clusters to a fulfillment service of the fulfillment services 108.

FIG. 7 illustrates a schematic block diagram of aspects of the present disclosure. The example of FIG. 7 includes the node database 102, clustering service 104, inventory database 106, fulfillment services 108, and the online ordering system 110, each of which is illustrated in the example of FIG. 1. Furthermore, components of FIG. 7 may, in some embodiments, communicate via the network 112 of FIG. 1. In the example of FIG. 7, the fulfillment services 108 includes a plurality of example fulfillment services 702-710, including the item availability service 702, the estimated delivery time service 704, the consolidation service 706, the order allocation service 708, and the shipping method service 710. In other examples, there may be more or fewer fulfillment services than those illustrated. One or more of the fulfillment services 702-710 may receive node data from the node database 102, clusters from the clustering service 104, or inventory data from the inventory database 106. In some embodiments, one or more of the fulfillment services 702-710 may provide node data updates to the node database 102, cluster data to the clustering service 104, or inventory updates to the inventory database 106. Furthermore, in some embodiments, one or more of the fulfillment services 702-710 may receive a request from the online ordering system 110. In response, one or more of the fulfillment services 702-710 may provide data to the online ordering system 110. Each of the fulfillment services 702-710 may perform one or more fulfillment tasks, examples of which are further described below for each of the fulfillment services 702-710.

The item availability service 702 may determine (e.g., in response to a request from the online ordering system 110) an availability for one or more items in a supply chain. To do so, the item availability service 702 may, in some embodiments, use the clusters provided by the clustering service 104. For example, the item availability service 702 may determine whether an item is available in any of the nodes of a cluster based on cluster-level inventory data (e.g., aggregated or collective availability data across the clustered locations). As a result, the item availability service 702 need not, in some embodiments, check each node of a cluster to determine whether an item is available in any of the nodes or to determine a quantity of an item across nodes in the cluster. That is, because each of the nodes of the cluster are similarly situated in terms of geographic proximity and item delivery capabilities, the aggregated availability information may be used with the assumption that item fulfillment can be accomplished equivalently by any individual node within that cluster, or cooperatively by two or more nodes of that cluster. In some embodiments, the item availability service 702 may, in response to determining that an item is unavailable at any nodes of a cluster (e.g., by checking the cluster-level inventory data), determine inventory data for another cluster by checking cluster-level inventory data for that cluster. In such a way, the item availability service 702 may determine item availability by searching cluster-level data, rather than searching data for each of the individual nodes of a cluster. In some embodiments, the item availability service 702 may determine a date by which an item will be available in a cluster, thereby enabling more accurate promised delivery times to an end user.

The estimated delivery time service 704 may determine an estimated delivery time for an order. For example, the estimated delivery time service 704 may receive an order from the online ordering system 110, and the order may include one or more items, a destination, and a shipping method. Based on such data, the estimated delivery time service 704 may determine an estimated delivery time, which may be a date, a day of the week, a datetime, a time of day, or another measure of time. To do so, the estimated delivery time service 704 may use another service of the fulfillment services 108 and may use data from one or more of the components 102-106.

For example, the estimated delivery time service 704 may use clusters provided by the clustering service 104 to determine an estimated delivery time for an item. For instance, the estimated delivery time service 704 may select one or more clusters with nodes having fulfillment features that correspond with characteristics of an order (e.g., if the order is for two-day shipping, then the estimated delivery time service 704 may determine item availability and shipping times only for clusters including nodes that offer two-day shipping). The estimated delivery time service 704 may determine item availability and shipping metrics for the one or more selected clusters. Furthermore, in some embodiments, the estimated delivery time service 704 may use fulfillment features (e.g., locale data, cutoff time data, transit data, carrier schedule data) of a cluster as part of predicting a shipping time to transport an item from a node of the cluster to a destination. In some embodiments, the estimated delivery time service 704 may provide an estimated delivery time to the online ordering system 110.

The consolidation service 706 may consolidate one or more items of an order. For example, the consolidation service 706 may receive an order having a plurality of items, and the consolidation service 706 may search one or more clusters provided by the clustering service 104 to find a cluster having each of the plurality of items. Furthermore, in some embodiments, the consolidation service 706 may, after selecting a cluster having each of the plurality of items, determine the nodes that have the items. In some embodiments, the clustering service 706 may determine whether there is a particular node having each of the plurality of items and, if so, the consolidation service 706 may select that node as an origin node for the order. In some embodiments, if the consolidation service 706 cannot find a particular node having each of the plurality of items, then the consolidation service 706 may search for another cluster having each of the plurality of items and then determine whether a node in that cluster has each of the plurality of items.

The order allocation service 708 may allocate an order to one or more clusters or to one or more nodes. For example, the order allocation service 708 may receive an order having one or more items. In some embodiments, the order allocation service 708 may determine cluster-level item availability to allocate an order to a cluster. By allocating an order to a cluster, the order allocation service 708 may generate a promise indicating that the one or more items are designated to be used for fulfilling an order. In some embodiments, a promise may also include data from another of the fulfillment services 108 (e.g., an estimated delivery time from the estimated delivery time service 704). In some embodiments, there may be a plurality of clusters to which the order allocation service 708 may allocate an order. In such instances, the order allocation service 708 may, in some embodiments, perform an optimization process that accounts for cluster characteristics, the order profile (e.g., order details, such as customer information, a channel by which an order was placed, when an order was placed, etc.), a carrier profile, and inventory data. In some embodiments, the optimization process may be implemented using a machine learning model.

In some embodiments, the order allocation service 708 may perform a soft allocation to a cluster. For example, the order allocation service 708 may determine that one or more nodes of a cluster will fulfill an order but may not determine exactly which nodes are the origin nodes. In some embodiments, the order allocation service 708 may move a soft allocation from one cluster to another in response to a change in inventory data. In some embodiments, the order allocation service 708 may allocate an order to one or more nodes of a cluster. In some embodiments, the order allocation service 708 may provide a promise or allocation plan to the online ordering system 110. In some embodiments, the order allocation service 708 may allocate an order to a cluster because the cluster is local to the destination of the order (e.g., the destination is in the same region or ZIP code as one or more of the nodes of the cluster), thereby enabling, in some instances, last-mile delivery shipping services for that order. In some embodiments, the order allocation service 708 may update inventory of the inventory database 106 (e.g., thereby ensuring that the one or more items are not thereafter promised for use in fulfilling another order). The inventory database 106, in turn, may provide an update to the inventory aggregator 222, thereby updating cluster-level inventory data.

The shipping method service 710 may perform one or more operations related to determining a shipping method for an item. In some embodiments, the shipping method service 710 may combine cluster-level inventory data and cluster data to determine available shipment options for a given item. For instance, if an item is available in a cluster, then the shipping method service 710 may determine the available shipment options for the item based on order fulfillment features of nodes of the that cluster. In some embodiments, one or more other fulfillment features may use the shipping method service 710 to perform their respective fulfillment tasks (e.g., the estimated delivery time service 704 or the order allocation service 708 may use the shipping method service 710 as part of determining an estimated delivery time or allocating an order to a location, respectively).

FIG. 8 illustrates a schematic block diagram of aspects of the present disclosure. The example of FIG. 8 includes the fulfillment services 108 and the online ordering system 110 from the environment 100 of FIG. 1, which may communicate, for example, via the network 112. The example of FIG. 8 further includes customers 812a-c which are communicatively coupled to the online ordering system 110 via the network 814 (e.g., the internet).

In the example of FIG. 8, the online ordering system 110 includes a plurality of example components 802-808, which include a web server 802, a mobile application server 804, a checkout service 806, and an item information service 808. In some embodiments, two or more components of the online ordering system 110 may be communicatively coupled with another. In some embodiments, the online ordering system 110 may be dispersed across various infrastructures and applications. Furthermore, in some embodiments, one or more components of the online ordering system 110 may itself include a plurality of components (e.g., the web server 802 and mobile application server 804 may include client-side and server-side components). Furthermore, in some embodiments, the online ordering system 110 may include more or fewer components than those shown.

In some embodiments, the customers 812a-c may interact with a client-side interface (e.g., a website display or mobile display) that is communicatively coupled with one or more of the web server 802 or mobile application server 804. The customers 812a-c may browse, search, and order items, and may perform other operations in connection with the online ordering system 110.

In some embodiments, one or more of the servers 802-804 may call one or more of the fulfillment services 108 or the services 806-808 to perform operations related to interacting with the customers 812a-c. Furthermore, one or more of the servers 802-804 may receive response data from the fulfilment services 108 or the services 806-808 and may provide aspects of the response data to the customers 812a-c. For example, the servers 802-804 may provide item information, estimated delivery times, available shipment options, shipment data, a confirmation, or other data generated by the fulfillment services 108 or the services 806-808 to the customers 812a-c.

For example, the web server 802 or mobile application server 804 may call the checkout service 806 in response to receiving an input from a customer indicating that the customer is putting an item in an online cart or is placing an order. The checkout service 806, in turn, may call one or more of the fulfillment services 108 to perform one or more operations related to placing an order (e.g., the checkout service 806 may provide a request to the estimated delivery time service 704 to determine an estimated delivery time of the order during checkout, a request to the order allocation service 708 to allocate the order to one or more clusters or nodes, or a request to another fulfillment service).

As another example, the web server 802 or the mobile application server 804 may call the item information service 808 in response to a customer input into an item display page or an item listing page (e.g., a customer search for items or a browse to a category of items). The item information service 808, in turn, may provide a request to one or more of the fulfillment services 108 to retrieve more item information, such as item availability information and information related to shipping and order fulfillment (e.g., the item information service 808 may provide a request to the item availability service 702 to determine item availability, a request to the shipping method service 710, or a request to another service of the fulfillment services 108).

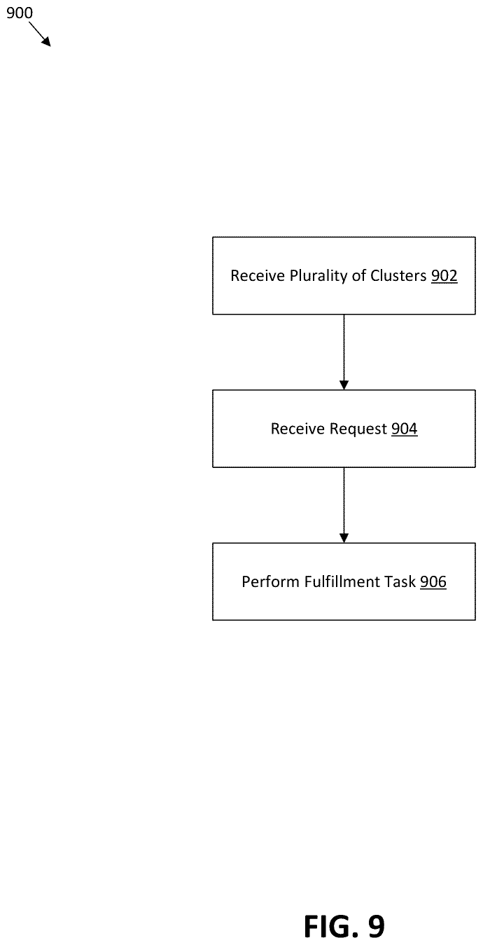

FIG. 9 is a flowchart of an example method 900. In some embodiments, one or more fulfillment services 108 may perform aspects of the method 900. For example, a fulfillment service of the fulfillment services 702-710 may perform aspects of the method 900.

In the example shown, a fulfillment service may receive a plurality of clusters (step 902). For example, the fulfillment service may receive a definition of a plurality of clusters from the clustering service 104. In some instances, the fulfillment service may receive updated clusters from the clustering service 104. To receive the plurality of clusters, the fulfillment service may, in some embodiments, query a database storing cluster data. In some embodiments, the fulfillment service may receive a data file having cluster data or may receive a data stream having cluster data. In some embodiments, each of the plurality of clusters may be associated with cluster-level inventory data. In some embodiments, the fulfilment service may receive cluster-level inventory data with the cluster data. In some embodiments, the fulfillment service may receive cluster-level inventory data from the inventory database 106 or the inventory aggregator 222.

In the example shown, the fulfillment service may receive a request (step 904). For example, the fulfillment service may receive a request from the online order system 110. Some example requests that a fulfillment service may receive include the following: placing an order for one or more items: retrieving item availability, either for a particular region or node, or for a supply chain more generally: retrieving item information: retrieving node or location data; retrieving available shipment options for one or more items: or performing another fulfillment task, such as a task related to browsing items, purchasing items, or managing item flow through a supply chain.

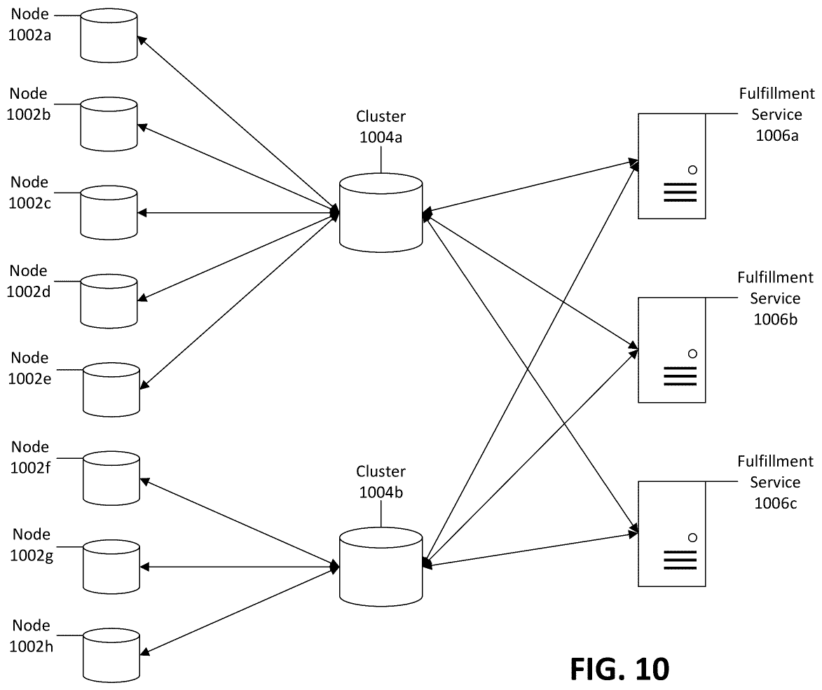

In the example shown, the fulfillment service may perform a fulfillment task (step 906). The performed fulfillment task may depend on the fulfillment service. For example, depending on the fulfillment service, the fulfillment task may relate to coordinating the flow of items in a supply chain, checking item availability, estimating delivery times, consolidating items, allocating orders, selecting or determining a shipment method, or another task related to order fulfillment. Examples of fulfillment tasks are further described above in connection with the fulfillment services 702-710 of FIG. 7. As described above, a fulfillment service may, in some instances, interact with clusters and cluster-level data, rather than interacting with individual nodes or individual node data, as part of performing a fulfillment task, as illustrated in FIG. 10.

FIG. 10 illustrates a schematic diagram illustrating aspects of the present disclosure. The example of FIG. 10 includes nodes 1002a-h, clusters 1004a-b, and fulfillment services 1006a-c. The arrows of FIG. 10 illustrate example data exchanges between components. In the example of FIG. 10, each of the nodes 1002a-h may correspond to data and computer systems related to a node of a supply chain. For example, the node 1002a may represent node and inventory data for a node and computer systems (e.g., databases, other memory, servers) for interacting with data of that node. Furthermore, each of the clusters 1004a-b may represent data of the cluster and computer systems (e.g., databases, other memory, servers) for interacting with data of the cluster. In the example shown, the cluster 1004a may include the nodes 1002a-e, and the cluster 1004b may include the nodes 1002f-h. Each of the fulfillment services 1006a-c may represent data and computing systems associated with one or more of the fulfillment services 108.

Continuing with the example of FIG. 10, the cluster 1004a may include aggregated data from the nodes 1002a-e. In some embodiments, such data aggregation may be performed by the clustering service 104 as part of forming clusters. The aggregated data may include, but is not limited to, inventory of the nodes 1002a-e, geographical coordinates of one or more of the nodes 1002a-e, or fulfillment features of the nodes 1002a-e, which may include locale data, cutoff time data, transit data, carrier schedule data, or shipping options data.

As shown, a fulfillment service (e.g., the fulfillment service 1006a) may retrieve data associated with the cluster 1004a (e.g., by calling a datastore that has data related to the cluster 1004a), rather than retrieve node data for each of the nodes 1002a-e, thereby reducing the computing costs associated with a task performed by the fulfillment service 1006a and reducing the latency time required for the fulfillment service 1006a to perform a task. In some embodiments, because the nodes 1002a-e are both geographically near one another and because they are sufficiently similar to one another with respect to fulfillment operations and timing, the fulfillment service 1006a can interact with data associated with the cluster 1004a, rather than each of the nodes 1002a-e, and accurately estimate a delivery time and gauge fulfillment metrics if an order is allocated to the cluster 1004a, even if an allocation to a particular node is not performed until a later time.

Furthermore, if the cluster 1004a is suboptimal for a fulfillment task (e.g., if the estimated delivery time is too slow, or if the cluster-level inventory data indicates that an item is unavailable in the cluster), then the fulfillment service 1006a may make a request to the cluster 1004b to retrieve data related to the nodes 1002f-h, thereby allowing the fulfillment service 1006a to efficiently retrieve and analyze data related to the nodes 1002a-h while only directly interacting with the cluster 1004a-b. Furthermore, in some in some instances, network traffic may be reduced because fewer data exchanges may be required between the cluster 1004a and the fulfillment service 1006a than would be required between the fulfillment service 1006a and each of the nodes 1002a-e. Yet still, in some instances, available storage space at the fulfillment service 1006a may increase, because less data may be required to retrieve data from the cluster 1004a than from each of the nodes 1002a-e.

Although additional operations may, in some instances, be required to update the cluster 1004a with new or updated data related to the nodes 1002a-e (e.g., updates to node inventory or changes to node features), such additional costs may be more than offset by operations avoided as a result of not querying the nodes 1002a-e each time that the fulfillment service 1006a requires data related to the nodes 1002a-e. Particularly at scale (e.g., in supply chains with hundreds or thousands of nodes), aspects of the present disclosure may, among other things, result in faster compute times, a reduced number of computer operations to perform a task, and memory and storage savings.

FIG. 11 illustrates aspects of an example user interface 1100 that may be used in connection with the clustering service 104. In some embodiments, an administrator may configure aspects of the clustering service 104 by using a user interface, such as the user interface 1100. In some embodiments, the clustering service 104 may not have a user interface, but aspects of the clustering service 104 (e.g., the selected geographical proximity model, selected fulfillment features, or the order of operations for generating clusters) may nevertheless be configured. In the example of FIG. 11, the user interface 1100 includes a geographical proximity model selection region 1102, a fulfillment features selection region 1104, and a clustering order selection region 1106.

The geographical proximity model selection region 1102 includes a plurality of input fields (e.g., check boxes and text input fields) for selecting a model for use when clustering nodes by geographical proximity, a process described above in connection with, for example, FIGS. 2-5. In the example shown, a user may select one or more of a DBSCAN, K-Means, or another model. Furthermore, one or more of the model options may include sub option input fields. In some embodiments, an administrator may, by using the sub option input fields, input parameters for use by the models, such as, for example, a number of clusters to form when using K-Means. Other input fields may also be used for setting other model parameters.

The fulfillment features selection region 1104 includes a plurality of input fields for selecting one or more fulfillment features to be used when clustering nodes based on similarity of fulfillment features, a process described above in connection with, for example, FIGS. 2-5. For example, depending on the embodiment or use case, an administrator may select fewer than all of the possible features for consideration when clustering nodes. In the example shown, the selectable fulfillment features include input fields (e.g., check boxes) for locale data, internal cutoff times, carrier cutoff times, transit data, carrier schedules, and shipping options, each of which is further described above in connection with FIG. 2.

Furthermore, in some embodiments, one or more of the fulfillment features may be associated with sub options for selecting or deselecting sub features. For instance, locale data may include a plurality of selectable sub features, such as time zone, region, and state, and a user may select one or more of the sub options for inclusion when clustering based on fulfillment features. As another example, one or more of the carrier transit data, and carrier schedules may include sub options related to particular carriers (e.g., such a sub option may allow an administrator to determine whether to consider similarity for a particular carrier when grouping by fulfillment features). Other options and sub options of the fulfillment features selection region 1104 include other fulfillment features described above in connection with FIG. 2 or other fulfillment features. In some embodiments, the fulfillment features selection region 1104 may also include one or more input fields for inputting feature weights, which may be used to assign relative priority to fulfillment features for use during clustering, as described above in connection with FIG. 2.

The clustering order selection region 1106 may include a plurality of input fields (e.g., radio buttons or another input field) for selecting an ordering of processes for generating clusters. As described above (e.g., in connection with FIG. 3), the clustering service 104 may, in some embodiments, form clusters by first forming general clusters and then forming subclusters. In the example of FIG. 11, the clustering order selection region 1106 includes a first option according to which the clustering service 104 forms general clusters based on geographical proximity and then forms subclusters based on fulfillment feature similarity (e.g., as described above in connection with steps 306-308 of the method 300 and FIG. 4). The clustering order selection region 1106 also includes a second option according to which the clustering service 104 forms general clusters based on similarity of fulfillment features and then forms subclusters based on geographical proximity (e.g., as described above in connection with steps 310-312 of the method 300 and FIG. 5). In some embodiments, the clustering order selection region 1106 may include other options than those illustrated.

In some embodiments, the user interface 1100 may include more or fewer components than those illustrated. For example, the user interface 1100 may also, in some embodiments, include one or more fields for inputting node data, or one or more locations of node data, for use in clustering. As another example, the user interface 1100 may include an input field for defining a frequency of, or conditions related to (e.g., events), updating clusters. In some examples, the user interface 1100 may also include one or more input fields for adding nodes, removing nodes, or altering node data.

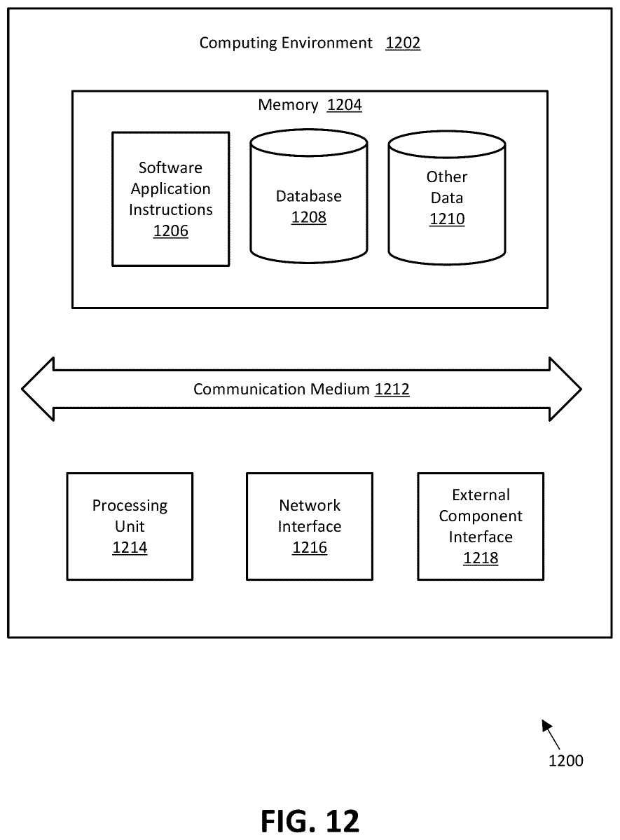

FIG. 12 illustrates an example system 1200 with which disclosed systems and methods can be used. In an example, the following can be implemented in one or more systems 1200 or in one or more systems having one or more components of system 1200: the node database 102, the clustering service 104, the inventory database 106, the fulfillment services 108, the online ordering system 110, the node data 202-212, the geographical proximity model 214, the fulfillment features evaluator 216, the inventory aggregator 222, the fulfillment services 702-710, the web server 802, the mobile application server 804, the checkout service 806, the item information service 808, the customers 812a-c, the nodes 1002a-h, the clusters 1004a-b, the fulfillment services 1006a-c, the user interface 1100, and other aspects of the present disclosure.

In an example, the system 1200 can include a computing environment 1202. The computing environment 1202 can be a physical computing environment, a virtualized computing environment, or a combination thereof. The computing environment 1202 can include memory 1204, a communication medium 1212, one or more processing units 1214, a network interface 1216, and an external component interface 1218.

The memory 1204 can include a computer readable storage medium. The computer storage medium can be a device or article of manufacture that stores data and/or computer-executable instructions. The memory 1204 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 1204 can store various types of data and software. For example, as illustrated, the memory 1204 includes software application instructions 1206, one or more databases 1208, as well as other data 1210. The communication medium 1212 can facilitate communication among the components of the computing environment 1202. In an example, the communication medium 1212 can facilitate communication among the memory 1204, the one or more processing units 1214, the network interface 1216, and the external component interface 1218. The communications medium 1212 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 1214 can include physical or virtual units that selectively execute software instructions, such as the software application instructions 1206. In an example, the one or more processing units 1214 can be physical products comprising one or more integrated circuits. The one or more processing units 1214 can be implemented as one or more processing cores. In another example, one or more processing units 1214 are implemented as one or more separate microprocessors. In yet another example embodiment, the one or more processing units 1214 can include an application-specific integrated circuit (ASIC) that provides specific functionality. In yet another example, the one or more processing units 1214 provide specific functionality by using an ASIC and by executing computer-executable instructions.

The network interface 1216 enables the computing environment 1202 to send and receive data from a communication network. The network interface 1216 can be implemented as an Ethernet interface, a token-ring network interface, a fiber optic network interface, a wireless network interface (e.g., Wi-Fi), a Bluetooth interface, or another type of network interface.

The external component interface 1218 enables the computing environment 1202 to communicate with external devices. For example, the external component interface 1218 can be a USB interface, Thunderbolt interface, a Lightning interface, a serial port interface, a parallel port interface, a PS/2 interface, or another type of interface that enables the computing environment 1202 to communicate with external devices. In various embodiments, the external component interface 1218 enables the computing environment 1202 to communicate with various external components, such as external storage devices, input devices, speakers, modems, media player docks, other computing devices, scanners, digital cameras, and fingerprint readers.

Although illustrated as being components of a single computing environment 1202, the components of the computing environment 1202 can be spread across multiple computing environments 1202. For example, one or more of instructions or data stored on the memory 1204 may be stored partially or entirely in a separate computing environment 1202 that is accessed over a network. Depending on the size and scale of the computing environment 1202, it may be advantageous to include one or more load balancers to balance traffic across multiple physical or virtual machine nodes. Each node may be configured to be capable of running the full system 1200, such that portal can run and schedule jobs and serve the portal user interface as long as a single node remains functional. The environment 1202 may include monitoring technology to determine when a node is not functioning so an appropriate action can be taken.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method for grouping a plurality of nodes of a supply chain, the method comprising:
receiving a plurality of geographical coordinates for the plurality of nodes, the plurality of geographical coordinates including, for each node of the plurality of nodes, geographical coordinates corresponding to a location of the node;
receiving a plurality of fulfillment features for the plurality of nodes, the plurality of fulfillment features including fulfillment features for each node of the plurality of nodes; and
grouping, based on the plurality of geographical coordinates and the plurality of fulfillment features, the plurality of nodes into a plurality of clusters, each of the plurality of clusters including one or more nodes of the plurality of nodes;
wherein grouping, based on the plurality of geographical coordinates and the plurality of fulfillment features, the plurality of nodes into the plurality of clusters comprises:
based on one of the plurality of geographical coordinates or the plurality of fulfillment features, grouping the plurality of nodes into a plurality of general clusters; and
determining a plurality of subclusters by, for each general cluster of the plurality of general clusters, grouping, based on one of the plurality of geographical coordinates or the plurality of fulfillment features, one or more nodes of the general cluster into one or more subclusters;
wherein at least one cluster of the plurality of clusters includes two or more nodes of the plurality of nodes.

2. The method of claim 1, further comprising providing the plurality of clusters to a fulfillment service.

3. The method of claim 1, wherein a majority of nodes of the plurality of nodes are retail stores.

4. The method of claim 1, wherein the plurality of nodes include one or more retail stores and one or more fulfillment centers.

5. The method of claim 1, wherein the plurality of geographical coordinates include, for each node of the plurality of nodes, a latitude and longitude of the location of the node.

6. The method of claim 1, wherein the plurality of fulfillment features include, for each node of the plurality of nodes, one or more of a time zone, a carrier schedule for a carrier associated with the node, a shipping option offered by the node, and a cutoff time.

7. The method of claim 1, wherein the plurality of fulfillment features include, for each node of the plurality of nodes, a plurality of carrier schedules for a plurality of carriers associated with the node.

8. The method of claim 1, wherein the plurality of fulfillment features include, for each node of the plurality of nodes, a historical time in transit.

9. The method of claim 1, wherein grouping, based on the plurality of geographical coordinates and the plurality of fulfillment features, the plurality of nodes into the plurality of clusters comprises applying a machine learning algorithm to the plurality of geographical coordinates to group the plurality of nodes based on geographical proximity.

10. The method of claim 1, further comprising:
providing the plurality of clusters to a fulfillment service;
receiving, at the fulfillment service, the plurality of clusters;
receiving, at the fulfillment service, an order; and
allocating the order to a cluster of the plurality of clusters.

11. The method of claim 1, further comprising providing the plurality of clusters to a fulfillment service:
receiving, at the fulfillment service, the plurality of clusters;
receiving, at the fulfillment service, an order from an online ordering system, the order including an item and a destination;
selecting a cluster of the plurality of clusters;
based at least in part on an aggregate inventory of the selected cluster, determining an availability of the item; and
based at least in part on the destination and the availability of the item, determining an estimated delivery time.

12. The method of claim 1, further comprising updating the plurality of clusters in response to one or more of a change of at least one fulfillment feature of the plurality of fulfillment features.

13. The method of claim 1, wherein the plurality of clusters is the plurality of subclusters.

14. The method of claim 1,
wherein, based on one of the plurality of geographical coordinates or the plurality of fulfillment features, grouping the plurality of nodes into the plurality of general clusters is performed by grouping the plurality of nodes into the plurality of general clusters based on the plurality of geographical coordinates; and
wherein, determining the plurality of subclusters by, for each general cluster of the plurality of general clusters, grouping, based on one of the plurality of geographical coordinates or the plurality of fulfillment features, the one or more nodes of the general cluster into the one or more subclusters is performed by grouping the one or more nodes of the general cluster into the one or more subclusters based on the plurality of fulfillment features.

15. The method of claim 1,
wherein, based on one of the plurality of geographical coordinates or the plurality of fulfillment features, grouping the plurality of nodes into the plurality of general clusters is performed by grouping the plurality of nodes into the plurality of general clusters based on the plurality of fulfillment features; and
wherein, determining the plurality of subclusters by, for each general cluster of the plurality of general clusters, grouping, based on one of the plurality of geographical coordinates or the plurality of fulfillment features, the one or more nodes of the general cluster into the one or more subclusters is performed by grouping the one or more nodes of the general cluster into the one or more subclusters based on the plurality of geographical coordinates.

16. A system for facilitating supply chain operations, the system comprising:
a clustering service comprising a processor and memory storing instructions that, when executed by the processor, cause the clustering service to:
receive a plurality of geographical coordinates for a plurality of nodes, the plurality of geographical coordinates including, for each node of the plurality of nodes, geographical coordinates corresponding to a location of the node;
receive a plurality of fulfillment features for the plurality of nodes, the plurality of fulfillment features including fulfillment features for each node of the plurality of nodes; and
group, based on the plurality of geographical coordinates and the plurality of fulfillment features, the plurality of nodes into a plurality of clusters, each of the plurality of clusters including one or more nodes of the plurality of nodes;
wherein grouping, based on the plurality of geographical coordinates and the plurality of fulfillment features, the plurality of nodes into the plurality of clusters comprises:
based on one of the plurality of geographical coordinates or the plurality of fulfillment features, grouping the plurality of nodes into a plurality of general clusters; and
determining a plurality of subclusters by, for each general cluster of the plurality of general clusters, grouping, based on one of the plurality of geographical coordinates or the plurality of fulfillment features, one or more nodes of the general cluster into one or more subclusters
wherein at least one cluster of the plurality of clusters includes two or more nodes of the plurality of nodes.

17. The system of claim 16, further comprising:
a fulfillment service communicatively coupled to the clustering service; and
an online ordering system communicatively coupled to the fulfillment service;
wherein the instructions, when executed by the processor, further cause the clustering service to provide the plurality of clusters to the fulfillment service; and
wherein the fulfillment service includes a second processor and second memory storing second instructions that, when executed by the second processor, cause the fulfillment service to:
receive the plurality of clusters;
receive an order from the online ordering system; and
using the plurality of clusters, execute a fulfillment task for the order.

18. The system of claim 17, wherein the fulfillment task is one or more of determining an availability of an item of the order or determining an estimated delivery time of the order.

19. The system of claim 18, wherein the instructions, when executed by the processor, further cause the clustering service to update the plurality of clusters based at least in part on data received by the online ordering system.

20. A non-transitory computer readable medium with instructions thereon that, when executed by a processor, cause the processor to:
receive a plurality of geographical coordinates for a plurality of nodes, the plurality of geographical coordinates including, for each node of the plurality of nodes, geographical coordinates corresponding to a location of the node;
receive a plurality of fulfillment features for the plurality of nodes, the plurality of fulfillment features including fulfillment features for each node of the plurality of nodes; and
group, based on the plurality of geographical coordinates and the plurality of fulfillment features, the plurality of nodes into a plurality of clusters, each of the plurality of clusters including one or more nodes of the plurality of nodes;
wherein grouping, based on the plurality of geographical coordinates and the plurality of fulfillment features, the plurality of nodes into the plurality of clusters comprises:
based on one of the plurality of geographical coordinates or the plurality of fulfillment features, grouping the plurality of nodes into a plurality of general clusters; and
determining a plurality of subclusters by, for each general cluster of the plurality of general clusters, grouping, based on one of the plurality of geographical coordinates or the plurality of fulfillment features, one or more nodes of the general cluster into one or more subclusters
wherein at least one cluster of the plurality of clusters includes two or more nodes of the plurality of nodes.
